(19) United States
(12) Patent Application Publication
(10) Pub. No.: US 2014/0132637 A1
(43) Pub. Date: May 15, 2014

(54) METHOD AND A DEVICE FOR DISPLAYING WALLPAPER CROPPING

(71) Applicant: Tencent Technology (Shenzhen) Co., Ltd., Shenzhen (CN)

(72) Inventors: Chongzhe YANG, Shenzhen (CN); Liang DENG, Shenzhen (CN)

(73) Assignee: Tencent Technology (Shenzhen) Co., Ltd., Shenzhen (CN)

(21) Appl. No.: 14/161,288

(22) Filed: Jan. 22, 2014

Related U.S. Application Data
(63) Continuation of application No. PCT/CN2013/086512, filed on Nov. 4, 2013.

(30) Foreign Application Priority Data
Nov. 5, 2012 (CN) 2012104350927

(51) Int. Cl. G06T 3/60; G06T 3/40

(52) U.S. Cl. CPC G06T 3/60; G06T 3/40
USPC 345/649

(57) ABSTRACT

The present disclosure is applicable to the technical field of image processing and provides a method and device for wallpaper cropping operations. The method separates and carries out the vertical and horizontal wallpaper cropping operations independently. More specifically, the method includes receiving by a mobile terminal, a command to start wallpaper cropping operations; acquiring a picture and a pending screen orientation information of the mobile terminal for performing the wallpaper cropping operations, wherein the performing of the wallpaper cropping operations include: performing a first wallpaper cropping operation on the picture according to the pending screen orientation information of the mobile terminal, and after completing the first wallpaper cropping operation; performing a second wallpaper cropping operation according to a subsequent screen orientation information, until remaining subsequent wallpaper cropping operations on the picture corresponding to remaining subsequent screen orientation information of the mobile terminal have been completed.

### CROSS-REFERENCE TO RELATED APPLICATIONS

This application is a continuation of PCT Application No. PCT/CN2013/086512, filed on Nov. 4, 2013, which claims priority to Chinese Patent Application No. 2012104350927, filed on Nov. 5, 2012, which is incorporated by reference in their entireties.

### FIELD OF THE TECHNOLOGY

The present application relates to the field of image processing, and more particularly to a method and a device for displaying a cropped image as wallpaper on a display screen of a mobile terminal, which may be viewed in different orientations when the mobile terminal is being rotated in reference to a center line.

### BACKGROUND

Mobile terminals that use an Android 4 operating system (such as a Nexus 7 or a Nexus 10 tablet device, or a smart phone) simultaneously crop a wallpaper image in both the vertical orientation and the horizontal orientation based on a cross-shaped cropping frame (also referred to as a cross-frame). FIGS. 1A through 1E illustrate exemplary operations of an existing cross-frame wallpaper cropping method.

FIG. 1A illustrates an example of an existing wallpaper cropping method on a mobile terminal (100) which uses a cross-frame (130) to simultaneously crop an image (120) to form corresponding vertically oriented wallpaper and horizontally oriented wallpaper for display on a screen (110). An image (120) may be imported locally from the mobile device (100), or downloaded remotely through a network (not shown). A user may re-size by zooming in or zooming out the image (120) displayed on the screen (110). The cross-frame (130) may be moved up or down, and left or right to select for a desired position before performing the simultaneous cropping operation.

FIG. 1B illustrates the cross-frame (130) which is used to simultaneously crop the image (120) to form corresponding vertically oriented wallpaper and horizontally oriented wallpaper for display on a screen (110) in the existing wallpaper cropping method. More specifically, the portion of image within the rectangle (132) represents the wallpaper to be displayed on the screen (110), when the mobile terminal is being held vertically (along the orientation of the center line A-A′ in FIG. 1A). The portion of image within the rectangle (134) represents the wallpaper to be displayed on the screen (110), when the mobile terminal is being held horizontally (rotated 90 degree to the left or to the right from the center line A-A′ in FIG. 1A).

FIG. 1C illustrates an example of a cross-frame cropping operation in the existing wallpaper cropping method. An image (140) may be imported and displayed as the tiger picture (140′) on the screen (110) from a local memory in the mobile device (100), or downloaded remotely through a network (not shown).

In this example, a user may prefer to display a full portion of the tiger (140′), as the horizontal wallpaper by zooming in or out, and positioning the rectangle 134 to include the entire tiger (140′) in the horizontal cropping operation. However, by doing so, the vertical cropping operation would also be simultaneously performed on the rectangle (132) portion of the cross-frame (130).

FIG. 1D illustrates an example of a vertical orientation wallpaper (140a) displayed on the mobile terminal (100) as a result of the simultaneous cross-frame cropping operation of FIG. 1C in the existing wallpaper cropping method. It should be noted that the cropped out portions of the tiger as shown in the vertical orientation wallpaper (140a) include at least the right front paw and a rear part of the tiger.

FIG. 1E illustrates an example of a horizontal orientation wallpaper (140b) displayed on the mobile terminal (100) as a result of the simultaneous cross-frame cropping operation of FIG. 1C in the existing wallpaper cropping method. It should be noted that the entire portion of the tiger is displayed in the horizontal orientation wallpaper (140b), as desired by the user in the cropping selection.

As seen, the existing method enables the user to adjust the size of the cross-frame (130) over the image (140′), and quickly perform simultaneous cropping operations vertically and horizontally. However, the existing method also limits user's controllability in achieving desirable results for both the vertical cropping operation and the horizontal cropping operation.

### SUMMARY

The embodiments of the present disclosure provide a method and a device for wallpaper cropping which improves the operability or controllability of vertical and horizontal wallpaper cropping operations.

The embodiments of the present disclosure adopt a method for wallpaper cropping comprising:
receiving by a mobile terminal, a command to start wallpaper cropping operations;
acquiring a picture and a pending screen orientation information of the mobile terminal for performing the wallpaper cropping operations, wherein the performing of the wallpaper cropping operations comprising:
   performing a first wallpaper cropping operation on the picture according to the pending screen orientation information of the mobile terminal, and after completing the first wallpaper cropping operation; and
   performing a second wallpaper cropping operation according to a subsequent screen orientation information, until remaining subsequent wallpaper cropping operations on the picture corresponding to remaining subsequent screen orientation information of the mobile terminal have been completed.

The embodiments of the present disclosure provide a device for wallpaper cropping operations, which includes at least a processor operating in conjunction with a memory and a plurality of units, the plurality of units include:
an information receiving unit which receives a command to start the wallpaper cropping operations;
an information acquisition unit which acquires a picture and pending screen orientation information of the mobile terminal for the wallpaper cropping operations; and
a cropping unit which performs the wallpaper cropping operations, wherein the cropping unit:
   performs a first wallpaper cropping operation on the picture according to the pending screen orientation information of the mobile terminal, and after completing the first wallpaper cropping operation; and
   performs a second wallpaper cropping operation according to a subsequent screen orientation information, until remaining subsequent wallpaper cropping operations on the picture corresponding to remaining subsequent screen orientation information of the mobile terminal have been completed.

The benefits of the embodiments of the present invention compared with the existing simultaneous vertical and horizontal cropping operations are that: each of the first wallpaper cropping operation, the second wallpaper cropping operation and the remaining subsequent wallpaper cropping operations is independent of each other, without predefining which portion of the picture should be cropped from one screen orientation to another screen orientation. In addition, the present disclosure enables a user to customize an appearance of the wallpaper in each of the first wallpaper cropping operation, the second wallpaper cropping operation and the remaining subsequent wallpaper cropping operations, wherein the customizing of the appearance of the wallpaper in each of the first wallpaper cropping operation, the second wallpaper cropping operation and the remaining subsequent wallpaper cropping operations including selecting one of: the same picture initially acquired or a different picture acquired in the corresponding subsequent screen orientation information. Accordingly, the present disclosure solves the problem of poor operability or controllability in the simultaneous vertical screen and horizontal screen cropping in the existing cropping method.

### BRIEF DESCRIPTION OF THE DRAWINGS

The accompanying drawings are included to provide a further understanding of the claims and disclosure, are incorporated in, and constitute a part of this specification. The detailed description and illustrated embodiments described serve to explain the principles defined by the claims.

FIG. 1A illustrates an example of an existing wallpaper cropping method on a mobile terminal which uses a cross-frame to simultaneously crop an image to form corresponding vertically oriented wallpaper and horizontally oriented wallpaper for display on a screen;

FIG. 1B illustrates the cross-frame which is used to simultaneously crop the image to form corresponding vertically oriented wallpaper and horizontally oriented wallpaper for display on a screen in the existing wallpaper cropping method;

FIG. 1C illustrates an example of a cross-frame cropping operation in the existing wallpaper cropping method;

FIG. 1D illustrates an example of a vertical orientation wallpaper displayed on the mobile terminal as a result of the simultaneous cross-frame cropping operation of FIG. 1C in the existing wallpaper cropping method;

FIG. 1E illustrates an example of a horizontal orientation wallpaper displayed on the mobile terminal as a result of the simultaneous cross-frame cropping operation of FIG. 1C in the existing wallpaper cropping method;

FIG. 2A illustrates an example of a vertical orientation wallpaper cropping operation on a mobile terminal, according to an embodiment of the present invention;

FIG. 2B illustrates an example of a vertical orientation wallpaper displayed on the mobile terminal as a result of selecting the vertical orientation wallpaper cropping operation in FIG. 2A, according to an embodiment of the present invention;

FIG. 2C illustrates an example of a horizontal orientation wallpaper cropping operation on a mobile terminal, according to an embodiment of the present invention;

FIG. 2D illustrates an example of a horizontal orientation wallpaper displayed on the mobile terminal as a result of selecting the horizontal orientation wallpaper cropping operation in FIG. 2C, according to an embodiment of the present invention;

FIGS. 2E and 2F illustrate an example of a result of a vertical orientation wallpaper cropping operation and a result of a horizontal orientation wallpaper cropping operation, wherein the wallpaper of the vertical orientation cropping is different from the wallpaper of the horizontal orientation cropping, according to another embodiment of the present invention;

FIG. 3 is a flow chart illustrating exemplary steps in carrying out wallpaper cropping operations, according to an embodiment of the present invention; and

FIG. 4 illustrates an exemplary wallpaper cropping device, according to an embodiment of the present invention.

### DETAILED DESCRIPTION OF THE EMBODIMENTS

The various embodiments of the present disclosure are further described in details in combination with attached drawings and embodiments below. It should be understood that the specific embodiments described here are used only to explain the present disclosure, and are not used to limit the present disclosure.

In order to make clearer the technical solution and advantages of the present disclosure, the present disclosure will be further described in detail in combination with the attached drawings and embodiments. It should be understandable that the embodiments are only used to interpret but not to limit the present disclosure. The technical solution of the present disclosure will be described via the following embodiments.

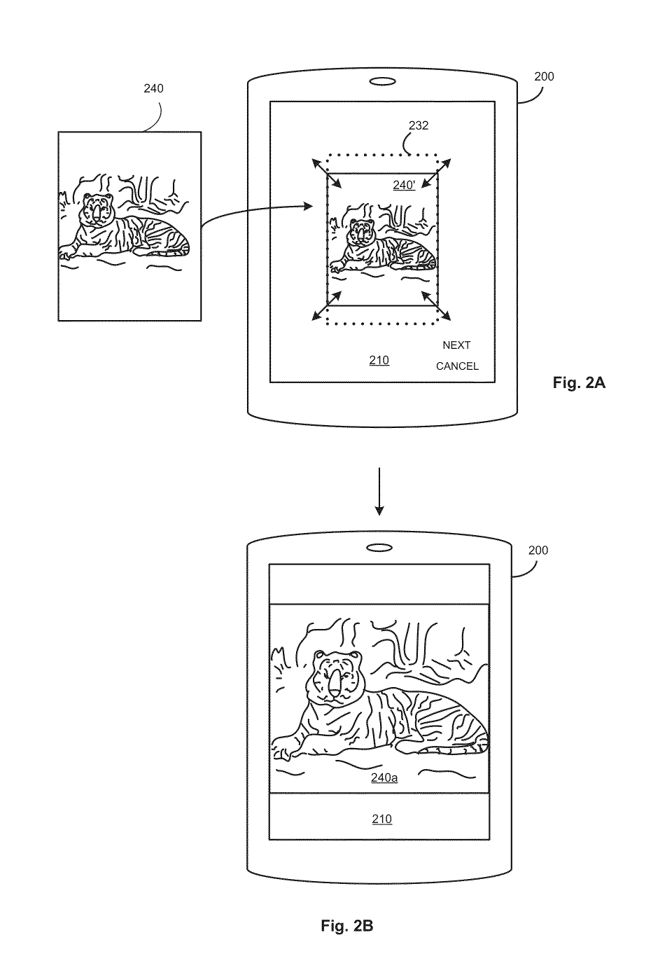

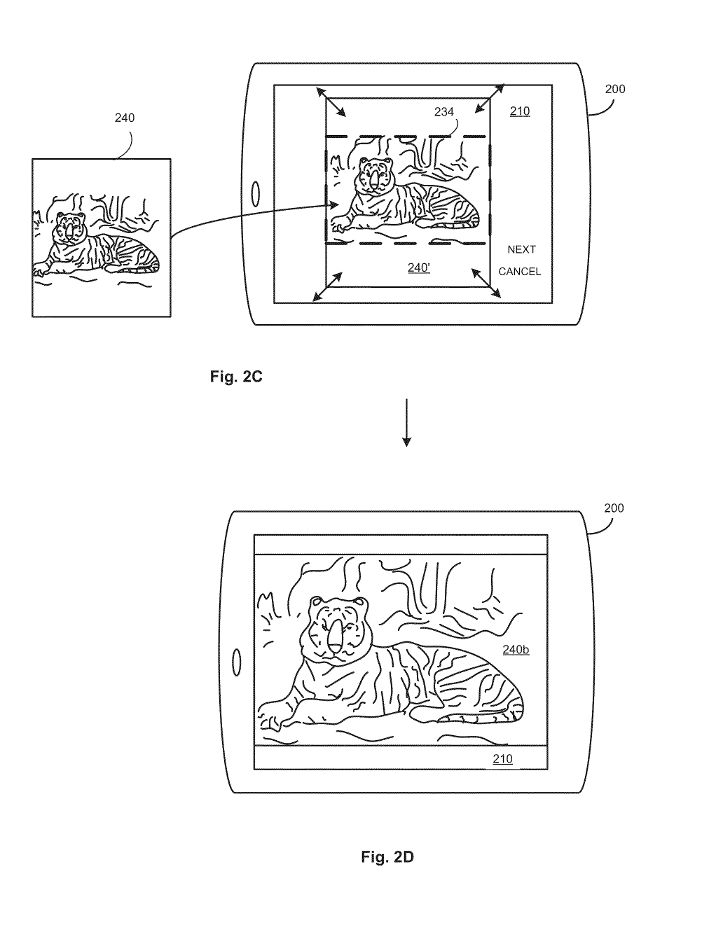

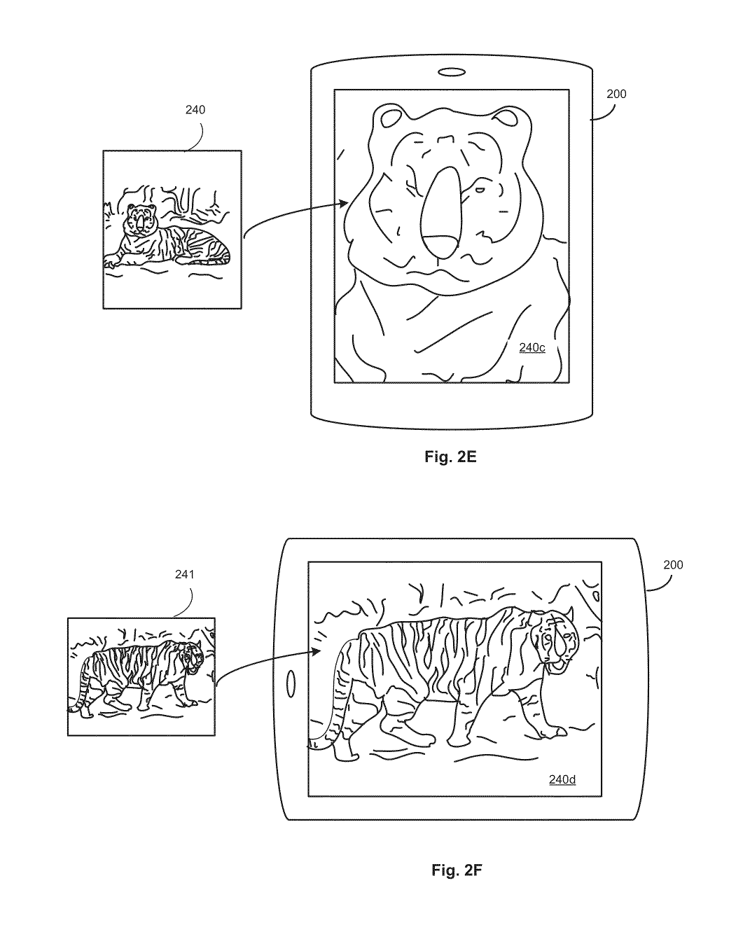

FIG. 2A illustrates an example of a vertical orientation wallpaper cropping operation on a mobile terminal (200), according to an embodiment of the present invention. The present disclosure, instead of using simultaneous vertical wallpaper cropping and horizontal wallpaper cropping operations, uses at least two independent and separate cropping operations, namely, a vertical wallpaper cropping operation and a horizontal wallpaper cropping operation. The order of which operation to start with is not important, since each operation is independent of each other. Moreover, the wallpaper cropping operations are not limited to vertical and horizontal orientations only, other cropping operations in other angles, such as 45 degrees, or other arbitrary angles may also be performed.

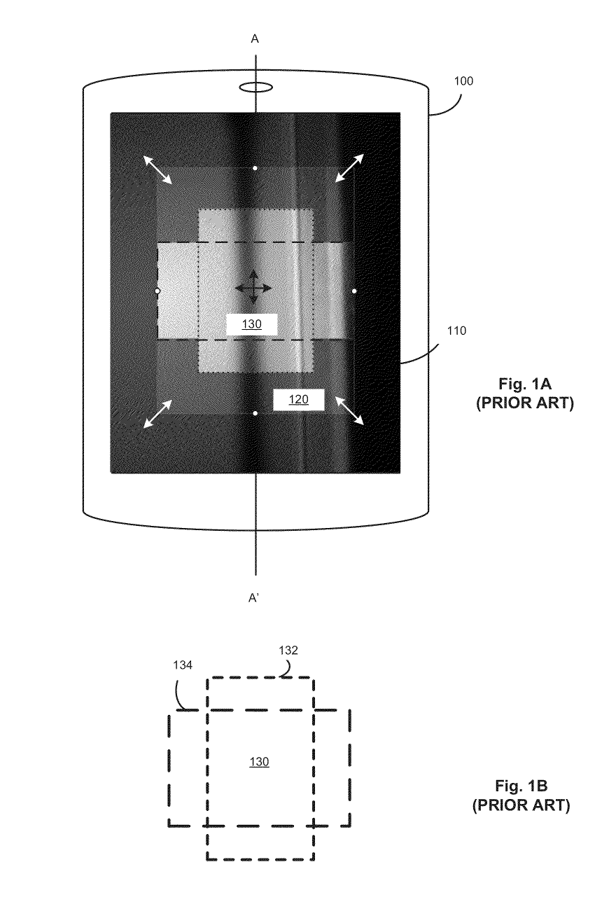

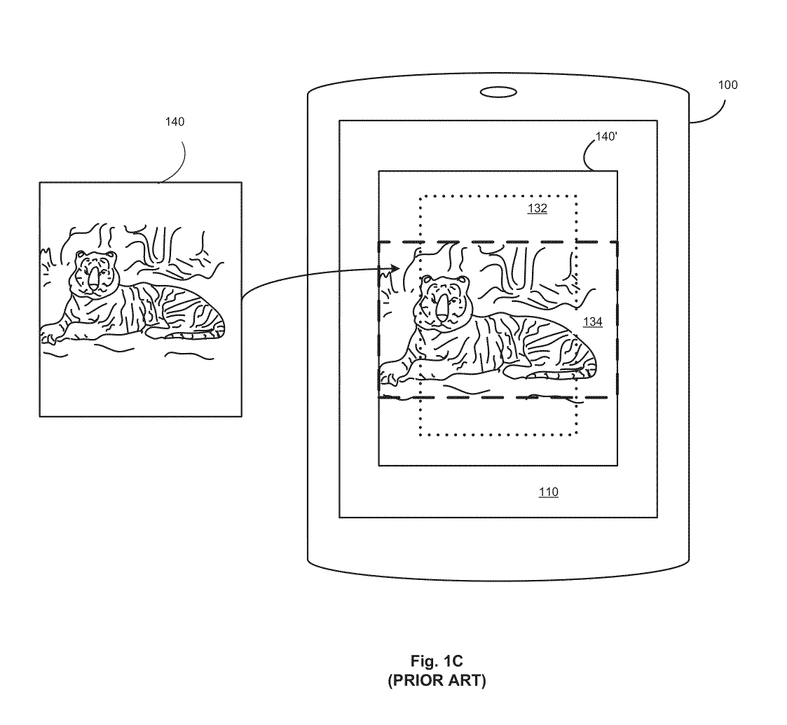

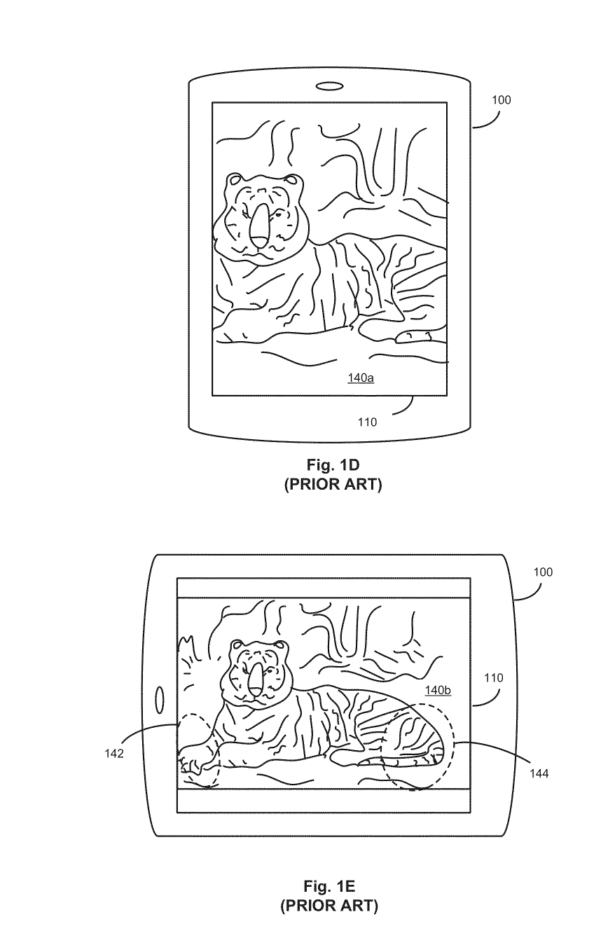

For the purpose of contrasting the present embodiment from the existing method as illustrated in FIGS. 1C through 1E, the same tiger picture (240) (i.e., the tiger picture (140)) may be imported from a local memory in the mobile device (200), or downloaded remotely through a network (not shown).

A user may re-size by zooming in or zooming out the tiger image (240′) displayed on the screen (210). In the present embodiment, the user may choose to first perform a vertical wallpaper cropping operation. A rectangle (232) may be displayed on the screen (210) as a vertical cropping frame. In this example, the user may prefer to display a full portion of the tiger (240′), as the vertical wallpaper by zooming the rectangle (232) in or out, up or down and positioning the rectangle (232) to select the entire tiger (240′) within the vertical cropping frame of the rectangle (232) before performing the vertical wallpaper cropping operation. By selecting the “NEXT” toolbar, the user confirms the vertical wallpaper cropping operation. Alternately, the user may select the “CANCEL” toolbar to cancel the selection and restart the vertical wallpaper cropping operation.

FIG. 2B illustrates an example of a vertical orientation wallpaper (240a) displayed on the mobile terminal (200) as a result of selecting the vertical orientation wallpaper cropping operation in FIG. 2A, according to an embodiment of the present invention. As shown, the full portion of the tiger (240′) is displayed according to the vertical wallpaper cropping operation.

FIG. 2C illustrates an example of a horizontal orientation wallpaper cropping operation on a mobile terminal, according to an embodiment of the present invention. For the purpose of illustration, the same tiger picture (240) which has been previously imported for the vertical wallpaper cropping operation may be reused for the horizontal wallpaper cropping operation. Alternately, a different picture may be retrieved from a local memory in the mobile device (200), or downloaded remotely through a network (not shown).

The user, likewise, may re-size by zooming in or zooming out the tiger image (240′) displayed on the screen (210). A rectangle (234) may be displayed on the screen (210) as a horizontal cropping frame. In this example, the user may prefer to display a full portion of the tiger (240′), as the horizontal wallpaper by zooming the rectangle (234) in or out, up or down and positioning the rectangle (234) to select the entire tiger (240′) within the horizontal cropping frame of the rectangle (234) before performing the horizontal wallpaper cropping operation. By selecting the “NEXT” toolbar, the user confirms the horizontal wallpaper cropping operation. Alternately, the user may select the “CANCEL” toolbar to cancel the selection and restart the horizontal wallpaper cropping operation.

FIG. 2D illustrates an example of a horizontal orientation wallpaper (240b) displayed on the mobile terminal (200) as a result of selecting the horizontal orientation wallpaper cropping operation in FIG. 2C, according to an embodiment of the present invention. As shown, the full portion of the tiger (240′) is displayed according to the horizontal wallpaper cropping operation.

In addition, additional subsequent wallpaper cropping operations in other arbitrary angles may be independently performed in similar manners, as illustrated in FIGS. 2A through 2D.

Furthermore, each of the vertical and the horizontal wallpaper cropping operations may be independently carried out respectively, where the corresponding results may be independently stored into a local memory upon completing each of the vertical wallpaper cropping operation, the horizontal wallpaper cropping operation and the remaining subsequent wallpaper cropping operations.

The present embodiment also includes receiving commands from the user to perform zooming and/or moving of the picture, such that the user may be enabled to preview an end result of the picture as the wallpaper in the corresponding vertical screen orientation or the horizontal screen orientation after the wallpaper cropping operations.

The wallpaper cropping operations on the picture (240) may further include performing of wallpaper cropping operation on the picture according to the pending screen orientation information or the subsequent screen orientation information, which may include: recording a start time of the vertical wallpaper cropping operation; and starting of the horizontal cropping operation. The starting of the horizontal cropping operation may include: judging if the start time of the vertical wallpaper cropping operation is same as a start time of a previous wallpaper cropping operation; if yes, continue the vertical wallpaper cropping operation; and if not, proceed to the horizontal cropping operation. In addition, the received command to start the wallpaper cropping operation is triggered by the user, or the triggering is generated by the mobile terminal (200) based on a preset time interval.

FIGS. 2E and 2F illustrate an example of a result of a vertical orientation wallpaper cropping operation and a result of a horizontal orientation wallpaper cropping operation, wherein the wallpaper (240c) of the vertical orientation cropping is different from the wallpaper (240d) of the horizontal orientation cropping, according to another embodiment of the present invention;

For the purpose of contrasting the new embodiment from the previous embodiment as illustrated in FIGS. 2A through 2D, the same tiger picture (240) may be imported from a local memory in the mobile device (200), or downloaded remotely through a network (not shown) for the vertical wallpaper cropping operation.

The user may re-size by zooming in or zooming out the tiger image (240′) displayed on the screen (210). In the second embodiment, the user may prefer to display only a face portion of the tiger (240) as the vertical wallpaper (240c) by zooming the rectangle (232) to select the tiger face only, as shown in FIG. 2E.

FIG. 2F illustrates a horizontal orientation wallpaper cropping operation on a mobile terminal (200), according to another embodiment of the present invention. For the purpose of contrasting the new embodiment from the previous embodiment as illustrated in FIGS. 2A through 2D, another new tiger picture (241) may be imported from a local memory in the mobile device (200), or downloaded remotely through a network (not shown) for the horizontal wallpaper cropping operation.

The user may re-size by zooming in or zooming out the new tiger picture (241) displayed on the screen (210). In the second embodiment, the user may prefer to display an entire portion of the tiger picture (241) as the horizontal wallpaper (240d) by zooming the rectangle (234) to select the entire tiger picture (241), as shown in FIG. 2F.

As shown in FIGS. 2E and 2F, each of the vertical wallpaper cropping operation, the horizontal wallpaper cropping operation and the remaining subsequent wallpaper cropping operations are independent of each other, without predefining which portion of the picture should be cropped from one screen orientation to another screen orientation.

Each of the vertical and the horizontal wallpaper cropping operations may be independently carried out respectively, where the corresponding results may be independently stored into a local memory upon completing each of the vertical wallpaper cropping operation, the horizontal wallpaper cropping operation and the remaining subsequent wallpaper cropping operations.

FIGS. 2A to 2F illustrates the various embodiments of customizing an appearance of the wallpaper in each of the first wallpaper cropping operation, the second wallpaper cropping operation and the remaining subsequent wallpaper cropping operations. The customizing of the appearance of the wallpaper in each of the first wallpaper cropping operation, the second wallpaper cropping operation and the remaining subsequent wallpaper cropping operations including selecting one of: the same picture initially acquired or a different picture acquired corresponding to another subsequent screen orientation information.

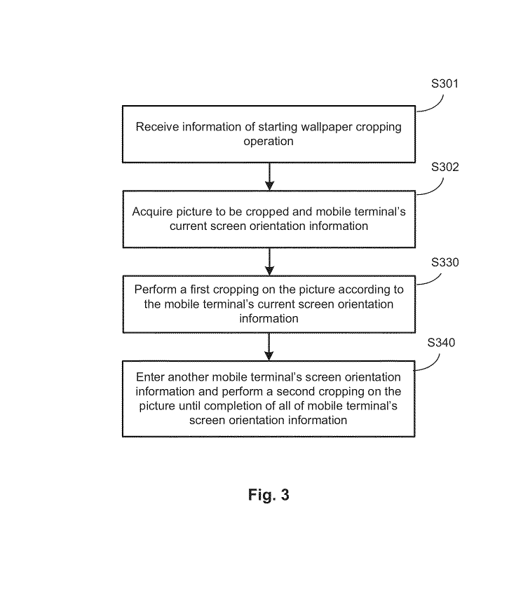

FIG. 3 is a flow chart illustrating exemplary steps in carrying out wallpaper cropping operations, according to an embodiment of the present invention.

In Step S301, the mobile terminal (200) may receive information of starting a wallpaper cropping operation.

In Step S302, the mobile terminal (200) may acquire a picture (240) to be cropped and the current screen orientation information (i.e., vertical orientation or horizontal orientation) of the mobile terminal (200). In this embodiment, the picture (240) to be cropped may be acquired from a local memory of the mobile terminal or from a network. The current screen orientation information of the mobile terminal may include vertical screen orientation information, horizontal screen orientation information, and inclined screen orientation information (for example, the mobile terminal forms a 45-degree angle relative to the vertical or horizontal line).

In Step S303, the mobile terminal (200) may crop the picture (240) according to the mobile terminal's current screen information.

In Step S304, the user may enter another screen orientation information, and the mobile terminal (2000 may perform a second wallpaper cropping operation on the picture (240), until completion of mobile terminal's remaining subsequent wallpaper cropping operations are completed.

The respective results may be stored after each of the wallpaper cropping operations, and the user may click the NEXT toolbar button to enter into a new wallpaper cropping operation in another screen orientation. The user may alternately, cancel and restart the operation by clicking the CANCEL toolbar button, or even return to the main menu to restart the wallpaper cropping operation.

By separating individual wallpaper cropping operations, the disclosure solves the problems of inflexibility or poor controllability due to the simultaneous vertical and horizontal cropping operations in the existing wallpaper cropping method. Moreover, when the cropping of a picture is completed, the effect of the completed picture when used as wallpaper may be previewed by zooming and/or moving the cropped picture, and the previewed effect is the same as that of the picture when it is finally returned and set as the desktop wallpaper, avoiding the problem of local zoom-in display of the wallpaper in the state of the art, which can reduce the user's visual experience (it should be specified that, in the state of the art, the wallpaper is automatically zoomed by the system instead of adjusted by the user). Besides, the screen size is taken as the size of the picture cropping frame, thus solving the problem whereby a part of the picture area cannot be cropped as the existing cropping frame can only be zoomed within the screen scope.

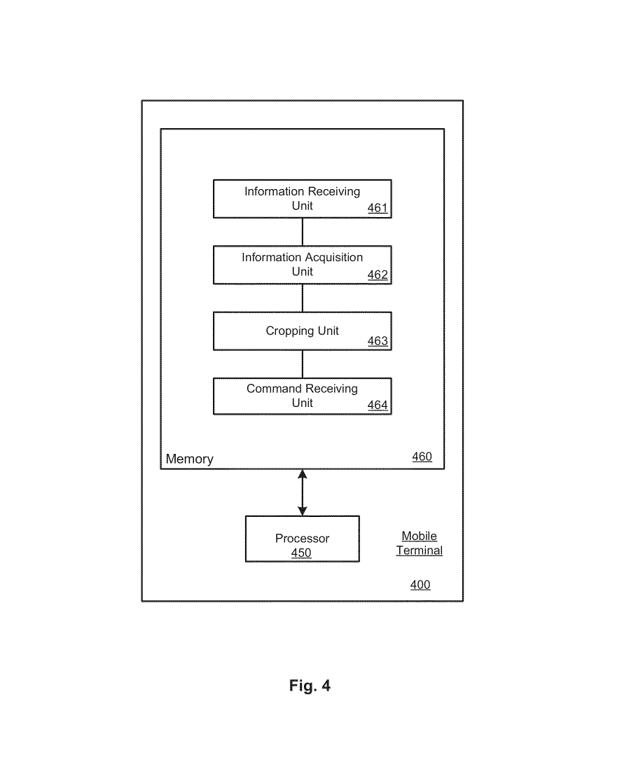

FIG. 4 illustrates an exemplary wallpaper cropping device (400), according to an embodiment of the present invention. To facilitate the description, only the parts relating to this embodiment of the present disclosure are shown.

The wallpaper cropping device (400) may include at least a processor (450) operating in conjunction with a local memory (460) to carry out wallpaper cropping operations. The disclosure may be implemented in both hardware and in software within the wallpaper cropping device (400). If implemented as software, the software may be stored in a non-transitory computer-readable medium having stored thereon, a computer program having at least one code section being executable by a processor in a machine for causing the machine to perform the functions or steps as described in FIGS. 2A to 2F. The machine may be a mobile terminal, a tablet device, a smart phone, a desktop computer, a display device or any computing platform which implements wallpaper display.

Referring to FIG. 4, the wallpaper cropping device (400) may include an information receiving unit (461), an information acquisition unit (462), a cropping unit (463) and a command receiving unit (464). In an embodiment, the information receiving unit (461), the information acquisition unit (462), the cropping unit (463) and the command receiving unit (464) may be implemented within the local memory (460). In another embodiment, the information receiving unit (461), the information acquisition unit (462), the cropping unit (463) and the command receiving unit (464) may be stored remotely in a cloud network, downloadable into a user's mobile terminal, or stored on a flash memory or the like in a non-transitory readable memory device.

The information receiving unit (461) may receive a command to start a wallpaper cropping operations. The information acquisition unit (462) may acquire a picture and pending screen orientation information of the mobile terminal (400) for the wallpaper cropping operations; and the cropping unit (463) may perform the wall cropping operations.

More specifically, the cropping unit (463) may perform the following functions: perform a first wallpaper cropping operation on the picture according to the pending screen orientation information of the mobile terminal, and after completing the first wallpaper cropping operation; and perform a second wallpaper cropping operation according to a subsequent screen orientation information, until remaining subsequent wallpaper cropping operations on the picture corresponding to remaining subsequent screen orientation information of the mobile terminal have been completed. Furthermore, the orientation information is not limited to only the vertical screen orientation and the horizontal screen orientation. The cropping unit (463) may independently store a corresponding result in a local memory, upon completing each of the first wallpaper cropping operation, the second wallpaper cropping operation and the remaining subsequent wallpaper cropping operations.

The wallpaper cropping device (400) may further include a command receiving unit (464) for receiving commands to perform zooming and/or moving of the picture, such that a user is enabled to preview an end result of the picture as the wallpaper in the corresponding vertical screen orientation or the horizontal screen orientation after the wallpaper cropping operation.

The wallpaper cropping operation on the picture may include: the cropping unit (463) performs a wallpaper cropping operation on the picture according to the pending screen orientation information or the subsequent screen orientation information acquired by the information acquisition unit (462). The cropping unit (463) may further perform: recording a start time of the first wallpaper cropping operation according to the pending screen orientation information; after completing the first wallpaper cropping operation, judging if the start time of the first wallpaper cropping operation is same as a start time of a previous wallpaper cropping operation; if yes, the cropping unit (463) may continue the first wallpaper cropping operation; and if not, the cropping unit (463) may proceed proceeds to the second cropping operation.

Further, the information of starting the wallpaper cropping function includes but is not limited to the command information of starting the wallpaper cropping function issued by the user, or the triggered information of starting the wallpaper cropping function generated based on the preset time interval.

Those of ordinary skill in the art can understand that the above mentioned units are only classified according to their functional logic, but are not limited to the classification as long as the corresponding functions can be realized; and are not to be limited in the scope of the present disclosure.

In addition, this embodiment of the present disclosure also provides a non-transitory computer-readable storage medium with computer-executable commands stored within. For example, the disclosure may be implemented as an algorithm as codes stored in a program module or a system with multi-program-modules. The computer-readable storage medium may be, for example, nonvolatile memory such as compact disc, hard drive or flash memory. The computer-executable commands are used to enable a computer or similar computing device to accomplish the wallpaper operations.

The foregoing represents only some preferred embodiments of the present invention and their disclosure cannot be construed to limit the present disclosure in any way. Those of ordinary skill in the art will recognize that equivalent embodiments may be created via slight alterations and modifications using the technical content disclosed above without departing from the scope of the technical solution of the present disclosure, and such summary alterations, equivalent changes and modifications of the foregoing embodiments are to be viewed as being within the scope of the technical solution of the present disclosure.

It will be apparent to those skilled in the art that various modifications and variations can be made to the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A method for wallpaper cropping, comprising:
receiving by a mobile terminal, a command to start wallpaper cropping operations;
acquiring a picture and a pending screen orientation information of the mobile terminal for performing the wallpaper cropping operations, wherein the performing of the wallpaper cropping operations comprising:
performing a first wallpaper cropping operation on the picture according to the pending screen orientation information of the mobile terminal; and after completing the first wallpaper cropping operation:
performing a second wallpaper cropping operation according to a subsequent screen orientation information, until remaining subsequent wallpaper cropping operations on the picture corresponding to remaining subsequent screen orientation information of the mobile terminal have been completed.

2. The method according to claim 1, comprising independently storing a corresponding result upon completing each of the first wallpaper cropping operation, the second wallpaper cropping operation and the remaining subsequent wallpaper cropping operations.

3. The method according to claim 1, wherein the pending and the subsequent screen orientation information comprise: a vertical screen orientation and a horizontal screen orientation, respectively, or vice versa.

4. The method according to claim 1, wherein the remaining subsequent screen orientation information comprises: a 45 degree angle orientation or any arbitrary angle orientation measured from a reference screen orientation of the mobile terminal.

5. The method according to claim 1, comprising:
receiving commands to perform zooming and/or moving of the picture, such that a user is enabled to preview an end result of the picture as the wallpaper in the corresponding first screen orientation or the second screen orientation after the wallpaper cropping operation.

6. The method according to claim 1, wherein the performing of wallpaper cropping operation further comprising:
recording a start time of the first wallpaper cropping operation; and
starting of the second cropping operation comprising:
judging if the start time of the first wallpaper cropping operation is same as a start time of a previous wallpaper cropping operation; if yes, continue the first wallpaper cropping operation; and if not, proceed to the second cropping operation.

7. The method according to claim 1, wherein the received command to start the wallpaper cropping operation is triggered by a user or is generated by the mobile terminal based on a preset time interval.

8. The method according to claim 1, wherein each of the first wallpaper cropping operation, the second wallpaper cropping operation and the remaining subsequent wallpaper cropping operations is independent of each other, without predefining which portion of the picture should be cropped from one screen orientation to another screen orientation.

9. The method according to claim 1, comprising customizing an appearance of the wallpaper in each of the first wallpaper cropping operation, the second wallpaper cropping operation and the remaining subsequent wallpaper cropping operations.

10. The method according to claim 9, wherein the customizing of the appearance of the wallpaper in each of the first wallpaper cropping operation, the second wallpaper cropping operation and the remaining subsequent wallpaper cropping operations comprising selecting one of: the same picture initially acquired or a different picture acquired corresponding to another subsequent screen orientation information.

11. A device for wallpaper cropping operations, comprises at least a processor operating in conjunction with a memory and a plurality of units, the plurality of units comprise:
an information receiving unit which receives a command to start the wallpaper cropping operations;
an information acquisition unit which acquires a picture and pending screen orientation information of the mobile terminal for the wallpaper cropping operations; and
a cropping unit which performs the wallpaper cropping operations, wherein the cropping unit:
performs a first wallpaper cropping operation on the picture according to the pending screen orientation information of the mobile terminal, and after completing the first wallpaper cropping operation; and
performs a second wallpaper cropping operation according to a subsequent screen orientation information, until remaining subsequent wallpaper cropping operations on the picture corresponding to remaining subsequent screen orientation information of the mobile terminal have been completed.

12. The device according to claim 11, wherein the cropping unit independently stores a corresponding result upon completing each of the first wallpaper cropping operation, the second wallpaper cropping operation and the remaining subsequent wallpaper cropping operations.

13. The device according to claim 11, wherein the pending and the subsequent screen orientation information comprise a vertical screen orientation and a horizontal screen orientation, respectively, or vice versa.

14. The device according to claim 11, wherein the remaining subsequent screen orientation information comprises: a 45 degree angle orientation or any arbitrary angle orientation measured from a reference screen orientation of the mobile terminal.

15. The device according to claim 11, further comprises:
a command receiving unit for receiving commands to perform zooming and/or moving of the picture, such that a user is enabled to preview an end result of the picture as the wallpaper in the corresponding pending screen orientation or the subsequent screen orientation after the wallpaper cropping operation.

16. The device according to claim 11, wherein the cropping unit performs wallpaper cropping operation on the picture according to the pending screen orientation information or the subsequent screen orientation information acquired by the information acquisition unit, and the cropping unit further performs:
recording a start time of the first wallpaper cropping operation according to the pending screen orientation information;
after completing the first wallpaper cropping operation, judging if the start time of the first wallpaper cropping operation is same as a start time of a previous wallpaper cropping operation; if yes, continues the first wallpaper cropping operation; and if not, proceeds to the second cropping operation.

17. The device according to claim 11, wherein the received command to start the wallpaper cropping operation is triggered by a user or is generated by the mobile terminal based on a preset time interval.

18. The device according to claim 11, wherein each of the first wallpaper cropping operation, the second wallpaper cropping operation and the remaining subsequent wallpaper cropping operations is independent of each other, without predefining which portion of the picture should be cropped from one screen orientation to another screen orientation.

19. The device according to claim 11, wherein the cropping unit customizes an appearance of the wallpaper in each of the first wallpaper cropping operation, the second wallpaper cropping operation and the remaining subsequent wallpaper cropping operations.

20. A non-transitory computer-readable medium having stored thereon, a computer program having at least one code section being executable by a machine for causing the machine to perform steps comprising:
receiving by a mobile terminal, a command to start wallpaper cropping operations;
acquiring a picture and a pending screen orientation information of the mobile terminal for performing the wallpaper cropping operations, wherein the performing of the wallpaper cropping operations comprising:
performing a first wallpaper cropping operation on the picture according to the pending screen orientation information of the mobile terminal; and after completing the first wallpaper cropping operation:
performing a second wallpaper cropping operation according to a subsequent screen orientation information, until remaining subsequent wallpaper cropping operations on the picture corresponding to remaining subsequent screen orientation information of the mobile terminal have been completed.
